(19) United States
(12) Patent Application Publication
(10) Pub. No.: US 2023/0311540 A1
(43) Pub. Date: Oct. 5, 2023

(54) RECORDING APPARATUS

(71) Applicant: SEIKO EPSON CORPORATION, Tokyo (JP)

(72) Inventor: Nobutaka SUZUKI, Shiojiri-shi (JP)

(21) Appl. No.: 18/191,653

(22) Filed: Mar. 28, 2023

(30) Foreign Application Priority Data
Mar. 29, 2022 (JP) 2022-054082

(51) Int. Cl. B41J 11/00

(52) U.S. Cl. CPC B41J 11/0045

(57) ABSTRACT

An apparatus includes: a transport path 3 that is provided in an apparatus main body 7 to transport a medium; a recording section 5 that is movable in a direction toward and away from the transport path 3; and a rack and pinion mechanism 9 that moves the recording section 5 in the direction toward and away from the transport path 3, wherein the rack and pinion mechanism 9 includes a rack 11 that is provided in the recording section 5 and is formed along a movement direction of the recording section 5 and a pinion 13 that is provided on the apparatus main body 7 and meshes with the rack 11, the recording section 5 can be attached to and detached from the apparatus main body 7, and a positioning section 19 is provided in the recording section 5 and the apparatus main body 7 for positioning so that the reference tooth 15 of the pinion 13 meshes with the reference groove 17 of the rack 11 when the recording section 5 is returned from the detached state to the attached state.

The present application is based on, and claims priority from JP Application Serial Number 2022-054082, filed Mar. 29, 2022 the disclosure of which is hereby incorporated by reference herein in its entirety.

### BACKGROUND

### 1. Technical Field

The present invention relates to a recording apparatus such as an ink jet printer.

### 2. Related Art

An example of this type of recording apparatus is described in JP-A-2012-158036. JP-A-2012-158036 discloses a recording apparatus in which a recording head can be moved between a recording execution position and a wiping position using a rack and pinion mechanism.

It is desirable that the recording head is detachable and attachable for malfunctions, maintenance, or the like. That is, it is desirable that a head unit having the recording head attachable to and detachable from the apparatus main body. However, with a structure that uses a rack and pinion mechanism to move the recording head, when the head unit is detached, that is, removed, from the apparatus main body and then attached to, that is, mounted in, the apparatus main body, it must be mounted so that a reference tooth of the pinion meshes with a reference groove of the rack. This is because if the reference tooth of the pinion and the reference groove of the rack are not meshed and are mounted misaligned, that is, mounted out of phase, there is a possibility that movement of the recording head cannot be controlled normally. However, JP-A-2012-158036 does not contain any description regarding this point.

### SUMMARY

In order to achieve the above problem, a recording apparatus according to this disclosure includes: a transport path that is provided in an apparatus main body to transport a medium; a recording section that is movable in a direction toward and away from the transport path; and a rack and pinion mechanism that moves the recording section in the direction toward and away from the transport path, wherein: the rack and pinion mechanism includes a rack that is provided to the recording section and that is formed along a movement direction of the recording section and a pinion that is provided to the apparatus main body and that meshes with the rack, the recording section is attachable to and detachable from the apparatus main body, and a positioning section is provided to the recording section and the apparatus main body for positioning so that a reference tooth of the pinion meshes with a reference groove of the rack when the recording section is returned from a detached state to an attached state.

### BRIEF DESCRIPTION OF THE DRAWINGS

FIG. 1 is a schematic configuration diagram of an entire recording apparatus according to a first embodiment.

FIG. 2 is a schematic perspective view of a key portion showing an “attached” state of a recording section according to the first embodiment.

FIG. 3 is a schematic perspective view of the key portion showing a “detached” state of the recording section according to the first embodiment.

FIG. 4A is a schematic perspective view of a key portion for explaining meshing between a reference tooth of a pinion and a reference groove of a rack.

FIG. 4B is another schematic perspective view of the key portion for explaining the meshing between the reference tooth of the pinion and the reference groove of the rack.

FIG. 5A is a diagram of key portion configuration showing reattachment of the recording section in the first embodiment.

FIG. 5B is an another diagram of key portion configuration showing the reattachment of the recording section in the first embodiment.

FIG. 5C is a still another diagram of key portion configuration showing the reattachment of the recording section in the first embodiment.

FIG. 6 is a schematic configuration diagram of a key portion of the recording section of the recording apparatus according to the first embodiment.

### DESCRIPTION OF EMBODIMENTS

The present disclosure will be described briefly. In order to overcome the above described problem, a recording apparatus according to a first aspect of the present disclosure includes: a transport path that is provided in an apparatus main body to transport a medium; a recording section that is movable in a direction toward and away from the transport path; and a rack and pinion mechanism that moves the recording section in the direction toward and away from the transport path, wherein: the rack and pinion mechanism includes a rack that is provided to the recording section and that is formed along a movement direction of the recording section and a pinion that is provided to the apparatus main body and that meshes with the rack, the recording section is attachable to and detachable from the apparatus main body, and a positioning section is provided to the recording section and the apparatus main body for positioning so that a reference tooth of the pinion meshes with a reference groove of the rack when the recording section is returned from a detached state to an attached state.

According to this aspect, the positioning section is provided to the recording section and to the apparatus main body for positioning so that the reference tooth of the pinion meshes with the reference groove of the rack when the recording section, which can be attached to or detached from the apparatus main body, is returned from the detached state to the attached state. With this configuration, when the recording section is detached from the apparatus main body and then reattached, the rack and the pinion mesh with each other in a state in which the reference tooth of the pinion and the reference groove of the rack are positioned by the positioning section so as to mesh. Therefore, it is possible to easily reattach the recording head to the apparatus main body in a state in which the movement of the recording head can be normally controlled.

The recording apparatus according to a second aspect of this disclosure is an aspect according to the first aspect, wherein the positioning section includes a convex portion disposed on one of the recording section and the apparatus main body and a guide portion disposed on the other of the recording section and the apparatus main body to guide and position the convex portion when returning the recording section to the attached state.

According to this aspect, the positioning section is composed of the convex portion and the guide portion that guides the convex portion to perform positioning when the recording section is returned to the attached state. Therefore, the positioning section can be realized with a simple structure.

The recording apparatus according to a third aspect of this disclosure is an aspect according to the second aspect, wherein the guide portion releases the state of guiding the convex portion in the attached state of the recording section. Here, “releases the state of guiding the convex portion” in “the guide portion releases the state of guiding the convex portion in the attached state of the recording section” means a state in which the rack is able to move by rotation of the pinion.

According to this aspect, the guide portion releases the state of guiding the convex portion in the attached state of the recording section. Thus, the rack can be moved by the rotation of the pinion, and the movement of the recording section can be controlled.

The recording apparatus according to a fourth aspect of this disclosure is an aspect according to the second aspect or to the third aspect, wherein the convex portion and the guide portion are disposed so as to be visible from an upstream side in an attachment direction when the recording section is moved in the attachment direction.

According to this aspect, the convex portion and the guide portion are disposed so as to be visible from an upstream side in the attachment direction when the recording section is moved in the attachment direction. Therefore, it is possible to guide the convex portion to the guide portion while visually checking, and to easily align the convex portion with the guide portion.

The recording apparatus according to a fifth aspect of this disclosure is an aspect according to any one of the second aspect to the fourth aspect, wherein the rack is disposed on a side surface portion of the recording section in a width direction, which intersects the movement direction of the recording section and the pinion is disposed at a position to mesh with the rack.

According to this aspect, since the rack and the pinion mesh at the side surface portion of the recording section, the size of the recording section relative to the medium transport direction can be small.

The recording apparatus according to a sixth aspect of this disclosure is an aspect according to any one of the second aspect to the fifth aspect, wherein rack and pinion mechanisms and positioning sections are disposed on both side surface portions of the recording section in the width direction, which intersects the movement direction of the recording section.

According to this aspect, the rack and pinion mechanisms are provided on both side surface portions of the recording section. This makes it possible to move the recording section in the movement direction while appropriately maintaining the posture of the recording section during movement.

The recording apparatus according to a seventh aspect of this disclosure is an aspect according to any one of the second aspect to the sixth aspect, wherein one of the convex portion and the guide portion is integrally formed with a member that forms the rack, and the other of the convex portion and the guide portion is attachable to and detachable from the apparatus main body.

According to this aspect, since the one of the above is integrally formed with the member that forms the rack, the number of components and assembly variations can be reduced. In addition, since the other one can be attached to and detached from the apparatus main body, it is easy to change the fixed position. Further, since the parts can be exchanged, the variations in parts can be canceled out.

The recording apparatus according to an eighth aspect of this disclosure is an aspect according to any one of the second aspect to the seventh aspect, wherein a second positioning section, which has the same function as the positioning section, is provided to an opposite side of the rack than is the positioning section.

According to this aspect, since the second positioning section is further provided, it is possible to prevent the recording section from rotating around the guide section as a rotation fulcrum when the detached recording section is reattached to the apparatus main body, compared to when the recording section is guided by the single positioning section.

The recording apparatus according to a ninth aspect of this disclosure is an aspect according to the eighth aspect, wherein the second positioning section has a height position different from that of the positioning section.

According to this aspect, since the second positioning section has a different height position from the positioning section, it is possible to prevent the recording section from being reattached in a tilted state with respect to the apparatus main body. Accordingly, it is possible to suppress meshing deviation between the rack and the pinion.

The recording apparatus according to a tenth aspect of this disclosure is an aspect according to the eighth aspect or the ninth aspect, wherein second positioning sections are disposed on both side surface portions of the recording section in a width direction, which intersects the movement direction of the recording section.

According to this aspect, since the second positioning sections are provided on both side surface portions of the recording section, it is possible to further prevent the recording section from rotating around the guide section as a rotation fulcrum when the detached recording portion is reattached to the apparatus main body.

### First Embodiment

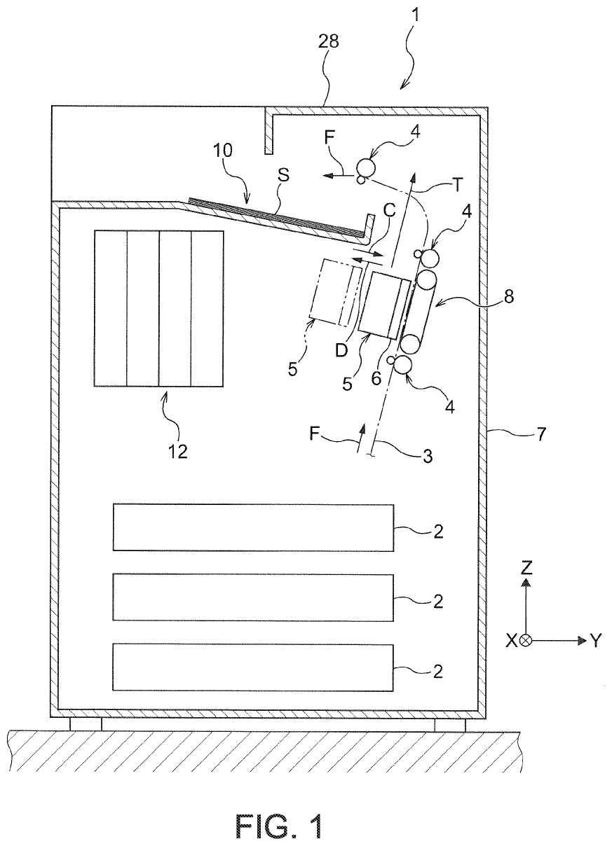

Hereinafter, the liquid ejection apparatus according to the first embodiment will be specifically described below with reference to FIGS. 1 to 6. In the following description, three axes orthogonal to each other are referred to as an X-axis, a Y-axis, and a Z-axis, respectively, as shown in the FIGS. 1 to 6. The Z-axis direction corresponds to a vertical direction, that is, a direction in which gravity acts. The X-axis direction and the Y-axis direction correspond to horizontal directions. In each figure, the direction indicated by the arrows on the three axes (X, Y, Z) is the +direction of each direction, and the opposite direction is the −direction.

As shown in FIG. 1, a recording apparatus 1 in this embodiment is an ink jet printer that prints by ejecting ink, which is a liquid, onto a medium S such as paper sheets. The medium S is stored in the medium accommodation section 2. The medium S is picked by a pickup roller, which is not shown, and sent to a transport path 3, where it is transported in a transport direction F by a plurality of transport rollers 4 located along the transport path 3. In FIG. 1, only a part of the transport rollers 4 is shown in order to avoid complication of the figure. Then, the medium S passes through a recording area of a recording section 5 located along the transport path 3, where recording is executed.

The recording section 5 has a recording head 6 that ejects ink. In this embodiment, the recording head 6 is a line head, but is not limited to a line head. There is a platen 8 with an endless belt structure at a position facing the recording head 6. The platen 8 forms the recording area between itself and the recording head 6. The medium S that was printed on by the recording head 6 is transported along the transport path 3 by the transport rollers 4 and discharged to the discharge tray 10. Reference numeral 12 is an ink accommodation section.

In this embodiment, the transport path 3 is arranged in the apparatus main body 7 in a state of being supported by structural members (not shown). The recording section 5 is provided so as to be movable in a direction approaching and separating from the transport path 3. In FIG. 1, the recording section 5 shown in solid line is at an adjacent position near the transport path 3, and the recording section 5 shown in broken line is at a separated position separated from the transport path 3. A recording section 5 performs recording at the adjacent position. Maintenance is performed on the recording head 6 of the recording section 5 at the separated position by a maintenance section (not shown).

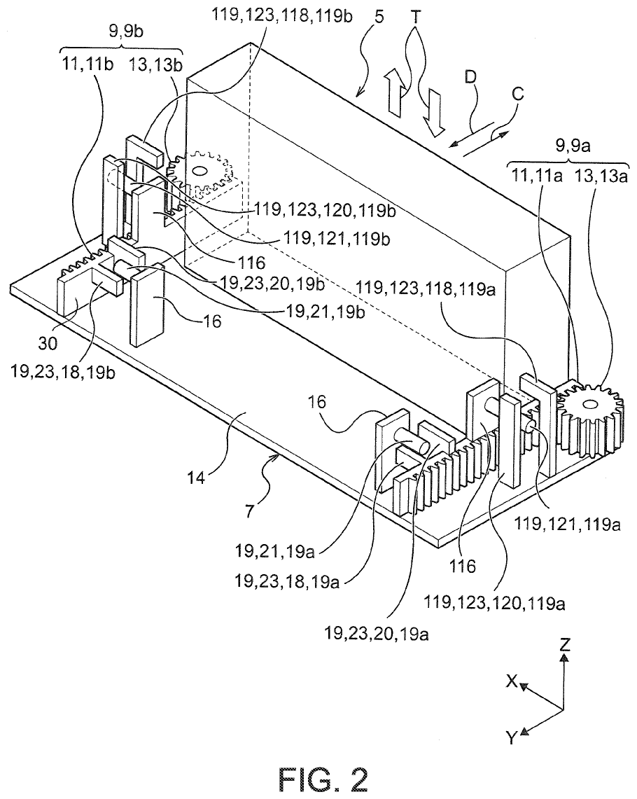

As shown in FIG. 2, in this embodiment, the recording section 5 is moved in an approaching direction C and in a separating direction D with respect to the transport path 3 by a rack and pinion mechanism 9. The rack and pinion mechanism 9 has a rack 11 provided to the recording section 5 and formed along the moving directions C and D of the recording section 5, and a pinion 13 provided to the apparatus main body 7 that meshes with the rack 11. The rack 11 and the pinion 13 are made of a synthetic resin material. The rack 11 is disposed on a side surface portion of the recording section 5 in the width direction (X-axis direction), which intersects with the moving directions C and D of the recording section 5. The pinion 13 is then disposed at a position where the pinion 13 meshes with the rack 11.

In this embodiment, rack and pinion mechanisms 9 are disposed on both side surface portions of the recording section 5 in the width direction (X-axis direction), which intersects the moving directions C and D. In the description of the rack and pinion mechanism 9, when the rack and pinion mechanisms 9 located on both side surface portions are to be distinguished from each other, symbols a and b are appended to the numerical symbols, as in rack and pinion mechanisms 9a and 9b. When the distinction is not made, a and b are omitted. This distinction is the same for other components in the following description. That is, the recording section 5 is moved in the approaching direction C and in the separating direction D with respect to the transport path 3 by the pair of rack and pinion mechanisms 9a and 9b. The rack and pinion mechanism 9a has a rack 11a provided to the recording section 5 and a pinion 13a provided to the apparatus main body 7. The rack and pinion mechanism 9b has a rack 11b provided to the recording section 5 and a pinion 13b provided to the apparatus main body 7.

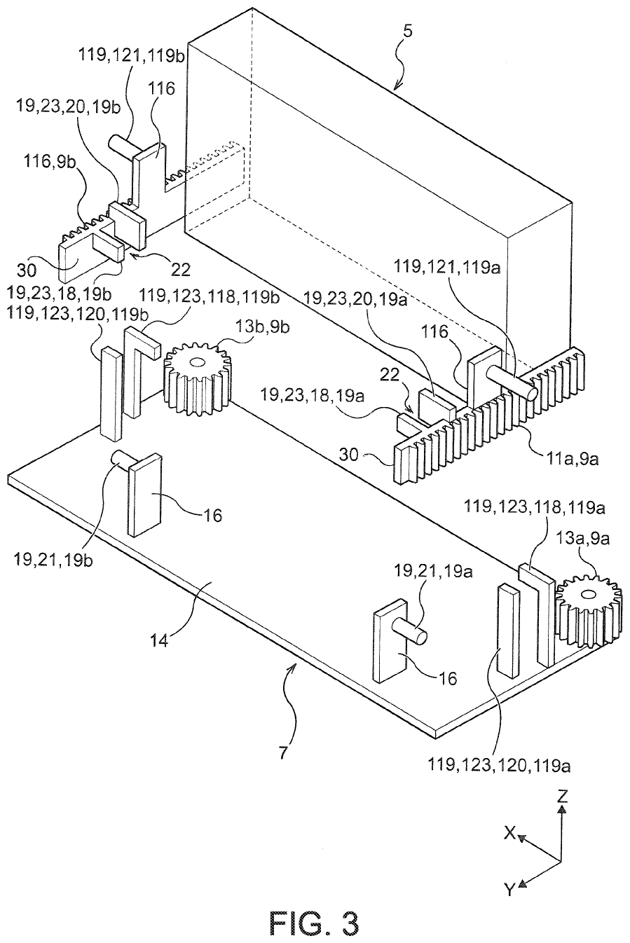

As shown in FIGS. 1 and 2, the recording section 5 is configured to be attached to and detached from the apparatus main body 7 in attach and detach directions T. FIG. 2 shows an “attached” state of the recording section 5, and FIG. 3 shows a “detached” state of the recording section 5. In this “detached” state, the rack 11 and the pinion 13 do not mesh. As shown in FIG. 1, the attach and detach directions T are slightly inclined from the Z-axis direction, which is the vertical direction in this embodiment. However, since the aforementioned inclination is practically unproblematic in the work of attaching and detaching, for the sake of simplicity, it is assumed that the attach and detach directions T are in the Z-axis direction in the explanation using FIG. 2 and thereafter. As shown in FIG. 3, by detaching the recording section 5 from the apparatus main body 7, that is by putting the recoding section 5 in the aforementioned “detached” state, the recording section 5 can be treated for malfunctions and other problems. After the malfunctions or other problems are corrected, the recording section 5 is reattached to the apparatus main body 7, that is, the recording section 5 is returned to the aforementioned “attached” state.

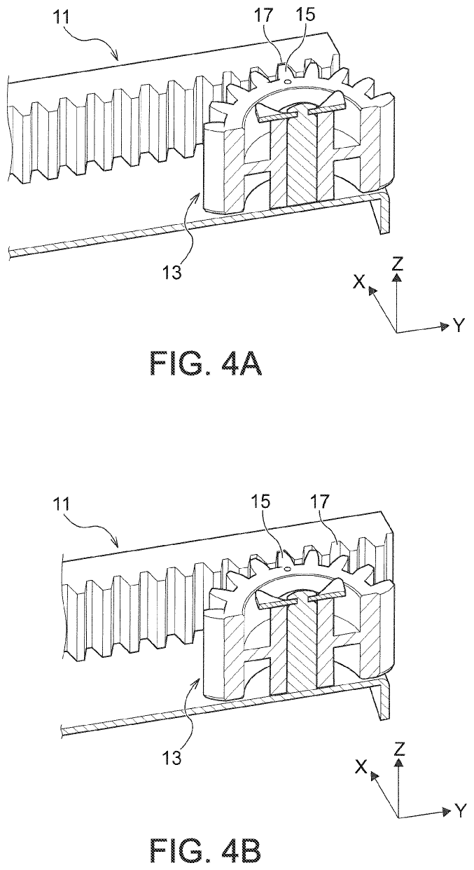

A positioning section 19 is provided to the recording section 5 and to the apparatus main body 7 for positioning to mesh a reference groove 17 of the rack 11 and a reference tooth 15 of the pinion 13 as shown in FIG. 4A, when returning the recording section 5 from the detached state (FIG. 3) to the attached state (FIG. 2). FIG. 4B shows a state in which the reference tooth 15 of the pinion 13 is not properly meshed with the reference groove 17 of the rack 11, that is, a state in which they are meshed out of alignment. The reason why the reference tooth 15 of the pinion 13 and the reference groove 17 of the rack 11 need to mesh properly is that this is necessary to control the movement of the recording section 5 by the rack and pinion mechanism 9. This is because if the teeth of the pinion 13 mesh with the groove of the rack 11 at an arbitrary position, movement control cannot be performed correctly.

### 1. Positioning Section

In this embodiment, as shown in FIGS. 2 and 3, positioning sections 19, in the same way as rack and pinion mechanisms 9, are also disposed on both side surface portions of the recording section 5 in the width direction (X-axis direction), which intersects the movement directions C and D of the recording section 5. The positioning section 19a of the rack and pinion mechanism 9a and the positioning section 19b of the rack and pinion mechanism 9b are arranged in plane symmetry. From the viewpoint of simplifying design and manufacturing, the positioning section 19a and the positioning section 19b are made with the same structure. Of course, they are not limited to the same structure.

In this embodiment, the positioning section 19 has a convex portion 21 disposed on the apparatus main body 7, and a guide portion 23 disposed on the recording section 5 that guides the convex portion 21 to perform the positioning when returning the recording section 5 to the “attached” state. The positioning section 19 may be arranged in the reverse configuration, with the guide portion 23 disposed on the apparatus main body 7 and the convex portion 21 disposed on the recording section 5. Specifically, as shown in FIGS. 2 and 3, the convex portion 21 is formed integrally with a fixing plate 16 fixed to a base portion 14, which constitutes a part of the apparatus main body 7. The shape of the convex portion 21 is not limited to the cylindrical shape with a circular cross section shown in the figures, but can also be a downward-facing U-shape in cross section with a curved outer surface, or other shape.

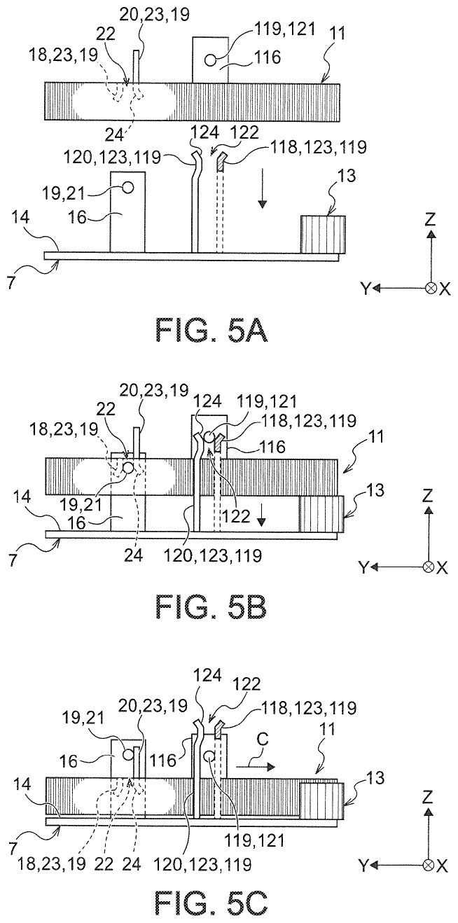

The guide portion 23 is integrally formed with a member in which the rack 11 is formed, which is disposed on the recording section 5. The guide portion 23 protrudes from a surface 30 (FIGS. 2 and 3) on which the rack 11 is not formed. The guide portion 23 has a slit 22 (FIG. 5) for passing and guiding the convex portion 21. In this embodiment, the slit 22 is formed by a pair of opposing plates 18 and 20. Of course, the slit 22 is not limited to a structure formed by the opposing plates 18 and 20. The guide for the positioning is performed by the convex portion 21 passing through the slit 22 of the guide portion 23 in the Z-axis direction, and this guide brings the reference tooth 15 of the pinion 13 and the reference groove 17 of the rack 11 into a meshed state. In FIGS. 2 and 3, the pair of opposing plates 18 and 20, which form the guide portion 23, are shown as simple plate shapes. However, as shown in FIG. 5, it is desirable to have a reverse tapered shape with a widened diameter portion 24 on the lower side (−Z direction) of the slit 22 portion. This is because the convex portion 21 can be easily guided to the slit 22 by the presence of the widened diameter portion 24.

In this embodiment, as shown in FIG. 5C, the guide portion 23 is configured to release the state of guiding the convex portion 21 in the “attached” state of the recording section 5. Specifically, the convex portion 21 is configured so that after passing through the slit 22 of the guide portion 23 in the −Z direction, as shown in FIG. 5C, it enters a positional relationship that does not interfere in the height direction with one of the opposing plates 18 comprising the guide portion 23. That is, in the state shown in FIG. 5C, the rack 11 can move in the −Y direction by rotation of the pinion 13.

In this embodiment, as shown in FIGS. 2 and 3, the guide portion 23 is integrally formed with the member on which the rack 11 is formed. On the other hand, the convex portion 21 is formed so as to be attachable to and detachable from the apparatus main body 7. Specifically, the fixing plate 16, in which the convex portion 21 is integrally formed, can be attached to and detached from the base portion 14, which constitutes a part of the apparatus main body 7, from the back of the base portion 14. Alternatively, the guide portion 23 may be detachably attached to the base portion 14, and the convex portion 21 may be integrally form with the member on which the rack 11 is formed. Further, in this embodiment, the convex portion 21 and the guide portion 23 are disposed so as to be visible from the upstream side in the “attachment” direction while the recording section 5 is moving in the “attachment” direction.

### 2. Second Positioning Section

In this embodiment, as shown in FIGS. 2 and 3, a second positioning section 119, which has the same function as the positioning section 19, is provided to the opposite side of the rack 11 than is the positioning section 19. Since the second positioning section 119 has the same function as the positioning section 19, the second positioning section 119 has members with similar functions corresponding to the convex portion 21, the guide portion 23, and other parts that make up the positioning section 19. Therefore, in the following description, each member of the second positioning section 119 will be denoted by a reference numeral obtained by adding 100 to the reference numeral of each member of the positioning section 19, that is, will be denoted in association with each member of the positioning section 19. For example, the convex portion 121 of the second positioning section 119 corresponds to the convex portion 21 of the positioning section 19. This is assumed to be an explanation that the convex portion 121 is provided with the same function as the convex portion 21, and the previously mentioned explanations of similar matters will be omitted. Further, the guide portion 123 of the second positioning section 119 corresponds to the guide portion 23 of the positioning section 19. This is assumed to be an explanation that the guide portion 123 is provided with the same function as the guide portion 23, and the previously mentioned explanations of similar matters will be omitted. The same applies to other components. Each corresponding component of both the second positioning section 119 and the positioning section 19 has a common function, but the shapes need not to be identical.

Second positioning sections 119, like the positioning sections 19, are disposed on both side surface portions of the recording section 5. That is, as shown in FIGS. 2 and 3, the second positioning section 119a and the second positioning section 119b are disposed. In this embodiment, the second positioning section 119 has the guide portion 123 disposed on the apparatus main body 7 and the convex portion 121 disposed on the recording section 5, contrary to the positioning section 19. Of course, like the positioning section 19, the structure may be such that the convex portion 121 is disposed on the apparatus main body 7 and the guide portion 123 is disposed on the recording section 5. In this embodiment, since the convex portion 121 is disposed on the recording section 5 side, the following configuration is adopted so that the recording section 5 can move in the −Y direction after the convex portion 121 passes through the slit 122 in the −Z direction and enters the state shown in FIG. 5C. That is, the opposing plate 118 is configured so that a portion thereof below the portion of the opposing plate 118 that constitutes the slit 122, does not interfere with the convex portion 121. That is, in the state shown in FIG. 5C, the rack 11 can move in the −Y direction by rotation of the pinion 13.

In this embodiment, the second positioning section 119 is configured to have a different height position from the positioning section 19. Here, as shown in FIGS. 5A to 5C, the second positioning section 119 is disposed at a position higher than the positioning section 19. The height position of the positioning section 19 is the position of the convex portion 21, and the height position of the second positioning section 119 is the position of a slit 122. The second positioning section 119 may be disposed at the same height position as the positioning section 19.

In FIGS. 2 and 3, the pair of opposing plates 118 and 120, which form the guide portion 123, are shown as a simple plate shapes. However, as shown in FIG. 5, it is desirable to have a reverse tapered shape with widened diameter portion 124 on the upper side (+Z direction) of the slit 122 portion. This is because the convex portion 121 can be easily guided to the slit 122 by the presence of the widened diameter portion 124.

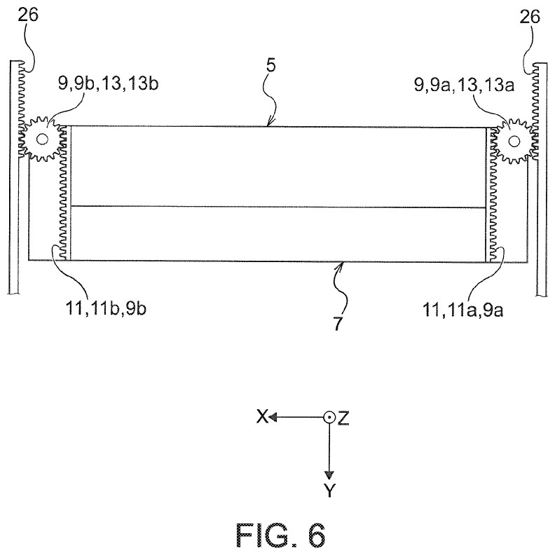

In this embodiment, as shown in FIG. 6, the pinions 13 also mesh with another racks 26. If the positions of the racks 26 are fixed and the pinions 13 are configured to be movable, rotation of the pinions 13 moves the racks 11 on the recording section 5 side in the −Y direction and simultaneously the pinions 13 move in the −Y direction over the other racks 26. This increases the moving distance of the recording section 5 in the −Y direction. In this structure, it is necessary that the reference tooth 15 of the pinion 13 and the reference groove 17 of the rack 11 correctly mesh. When controlling the movement of the recording section 5 by the rack and pinion mechanism 9, if the tooth of the pinion 13 and the groove of the rack 11 do not mesh correctly as shown in FIG. 4A, but instead mesh at a misaligned position as shown in FIG. 4B, the movement control cannot be performed correctly. Specifically, the problem occurs that a movement distance of the recording section 5 in the −Y direction changes for the same rotation amount of the pinion 13.

3. Reattachment of the Recording Section after Detachment

In FIG. 1, an upper surface portion 28 of the apparatus main body 7 is opened, then the recording section 5 is lifted upward (T direction) and removed. After that recording section 5 has been repaired, the operator moves the recording section 5, which is in the “detached” state shown in FIGS. 3 and 5A, downward (−Z direction). As shown in FIG. 5B, before the rack 11 portion of the recording section 5 meshes with the pinion 13 on the apparatus main body 7 side, a positioning is performed by the positioning section 19. Specifically, the convex portion 21 on the apparatus main body 7 side contacts the widened diameter portion 24 of the guide portion 23 on the recording section 5 side, and the convex portion 21 is guided into the slit 22. As a result, the reference tooth 15 of the pinion 13 and the reference groove 17 of the rack 11 enter a meshed state. The rack 11 and the pinion 13 may mesh at the same time as the aforementioned positioning by the positioning section 19 is performed. When the recording section 5 is moved further downward, it returns to the original “attached” state shown in FIG. 5C. In this “attached” state, the guide portion 23 releases the state of guiding the convex portion 21. That is, in the state shown FIG. 5C, the rack 11 can move in the −Y direction by the rotation of the pinion 13.

The second positioning section 119 acts in the same way as the positioning section 19. That is, the second positioning section 119 is configured to start positioning at the same timing that the positioning section 19 starts positioning. The above timing does not have to strictly coincide. As shown in FIG. 5B, before the rack 11 portion of the recording section 5 meshes with the pinion 13 on the apparatus main body 7 side, the positioning is performed by the positioning section 119. Specifically, the convex portion 121 on the recording section 5 side contacts the widened diameter portion 124 of the guide portion 123 on the apparatus main body 7 side, and the convex portion 121 is guided into the slit 122. As a result, the reference tooth 15 of the pinion 13 and the reference groove 17 of the rack 11 enter a meshed state. The rack 11 and the pinion 13 may mesh at the same time as the aforementioned positioning by the second positioning section 119 is performed. When the recording section 5 is moved further downward, it returns to the original “attached” state shown in FIG. 5C. In this “attached” state, the guide portion 123 releases the state of guiding the convex portion 121. That is, in the state shown FIG. 5C, the rack 11 can move in the −Y direction by the rotation of the pinion 13. Although not shown, bearings are provided on both side surface portions of the recording section 5, and guide rails are provided on the apparatus main body 7. When the recording section 5 is reattached, before the positioning by the positioning section 19 or the like is started, the recording section 5 is supported so that it can move in the movement direction with the bearings guided by the guide rails. The recording section 5 is guided by the guide rails and the bearings so that positioning by the positioning section 19 or the like is easily started.

### 4. Description of Effects of the Embodiment

(1) According to this embodiment, the positioning section 19 is provided to the recording section 5 and on the apparatus main body 7 and, when the recording section 5, which can be attached to and detached from the apparatus main body 7, is returned from the “detached” state to the “attached” state, positions the reference tooth 15 of the pinion 13 and the reference groove 17 of the rack 11 so as to mesh. As a result, when the recording section 5 is detached from the apparatus main body 7 and attached again, the rack 11 and the pinion 13 mesh with each other in a state which is positioned by the positioning section 19 so that the reference tooth 15 of the pinion 13 and the reference groove 17 of the rack 11 mesh. Therefore, the recording head can be easily reattached to the apparatus main body 7 in a state in which the movement of the recording head 6 can be controlled normally.

(2) Further according to this embodiment, the positioning section 19 includes the convex portion 21, and the guide portion 23 that guides the convex portion 21 and performs the positioning when the recording section 5 is being returned to the “attached” state. Thus, the positioning section 19 can be realized with a simple structure.

(3) According to this embodiment, the guide portion 23 releases the state of guiding the convex portion 21 in the “attached” state of the recording section 5. Thus, the rack 11 can be moved by the rotation of the pinion 13, and the movement of the recording section 5 can be controlled.

(4) According to this embodiment, the convex portion 21 and the guide portion 23 are disposed so as to be visible from the upstream side in the “attachment” direction when the recording section 5 is moved in the “attachment” direction. As a result, it is possible to guide the convex portion 21 to the guide portion 23 while visually checking the convex portion 21, and to easily align the convex portion 21 with the guide portion 23.

(5) According to this embodiment, since the rack 11 and the pinion 13 mesh with each other at the side surface portion of the recording section 5, the size of the recording section 5 with respect to the medium transport direction F can be small.

(6) According to this embodiment, the rack and pinion mechanisms 19 are provided on both side surface portions of the recording section 5. As a result, the recording section 5 can be moved in the movement directions C and D while appropriately maintaining the posture of the recording section 5 during movement.

(7) According to this embodiment, one of the convex portion 21 and the guide portion 23 is integrally formed with the member on which the rack 11 is formed. Therefore, the number of components can be reduced, and variation in assembly can be reduced. Further, since the other of the convex portion 21 and the guide portion 23 can be attached to and detached from the apparatus main body 7, it is easy to change the fixed position. Further, since the parts can be exchanged, the variations in parts can be canceled out.

(8) According to this embodiment, the second positioning section 119 is further provided, so that when the detached recording section 5 is reattached in the apparatus main body 7, the recording section 5 is prevented from rotating around the guide portion 23 as a rotation fulcrum, compared to when guided by a single positioning section.

(9) According to this embodiment, the second positioning section 119 has a different height position from the positioning section 19, which can prevent the recording section 5 from being reattached in a tilted state with respect to the apparatus main body 7. Accordingly, it is possible to suppress the meshing deviation between the rack 11 and the pinion 13.

(10) According to this embodiment, since the second positioning sections 119 are provided on both side surface portions of the recording section 5, it is possible to further prevent the recording portion 5 from rotating around the guide portion 123 as a rotation fulcrum when the detached recording section 5 is reattached to the apparatus main body 7.

### OTHER EMBODIMENTS

The recording apparatus according to this disclosure basically has the configuration of the embodiment described above, but it is needless to say that a partial change, omission, or the like of the configuration can be made without departing from the scope of the present disclosure. In the above embodiment, the structure with the positioning section 19 and the second positioning section 119 is described, but it is not limited to this, and a structure in which only one of the positioning section 19 and the second positioning section 119 may be provided. Further, the specific structure of the positioning section 19 is not limited to the structure of the convex portion 21 and the guide portion 23 described above. Any structure may be employed as long as the reference tooth 15 of the pinion 13 and the reference groove 17 of the rack 11 can be positioned so as to mesh with each other.

What is claimed is:

1. A recording apparatus comprising:
a transport path that is provided in an apparatus main body to transport a medium;
a recording section that is movable in a direction toward and away from the transport path; and
a rack and pinion mechanism that moves the recording section in the direction toward and away from the transport path,
wherein:
the rack and pinion mechanism includes
a rack that is provided to the recording section and that is formed along a movement direction of the recording section and
a pinion that is provided to the apparatus main body and that meshes with the rack,
the recording section is attachable to and detachable from the apparatus main body, and
a positioning section is provided to the recording section and the apparatus main body for positioning so that a reference tooth of the pinion meshes with a reference groove of the rack when the recording section is returned from a detached state to an attached state.

2. The recording apparatus according to claim 1, wherein:
the positioning section includes
a convex portion disposed on one of the recording section and the apparatus main body and
a guide portion disposed on the other of the recording section and the apparatus main body to guide and position the convex portion when returning the recording section to the attached state.

3. The recording apparatus according to claim 2, wherein:
the guide portion releases the state of guiding the convex portion in the attached state of the recording section.

4. The recording apparatus according to claim 2, wherein:
the convex portion and the guide portion are disposed so as to be visible from an upstream side in an attachment direction when the recording section is moved in the attachment direction.

5. The recording apparatus according to claim 2, wherein:
the rack is disposed on a side surface portion of the recording section in a width direction, which intersects the movement direction of the recording section and
the pinion is disposed at a position to mesh with the rack.

6. The recording apparatus according to claim 2, wherein:
rack and pinion mechanisms and positioning sections are disposed on both side surface portions of the recording section in the width direction, which intersects the movement direction of the recording section.

7. The recording apparatus according to claim 2, wherein:
one of the convex portion and the guide portion is integrally formed with a member that forms the rack, and
the other of the convex portion and the guide portion is attachable to and detachable from the apparatus main body.

8. The recording apparatus according to claim 1, wherein:
a second positioning section, which has the same function as the positioning section, is provided to an opposite side of the rack than is the positioning section.

9. The recording apparatus according to claim 8, wherein:
the second positioning section has a height position different from that of the positioning section.

10. The recording apparatus according to claim 8, wherein:
second positioning sections are disposed on both side surface portions of the recording section in a width direction, which intersects the movement direction of the recording section.
